(19) United States
(12) Patent Application Publication
(10) Pub. No.: US 2026/0242100 A1
(43) Pub. Date: Aug. 20, 2026

(54) CONTAINER AND METHOD OF MANUFACTURING

(71) Applicant: Michael D. Dwork, Westport, CT (US)

(72) Inventor: Michael D. Dwork, Westport, CT (US)

(21) Appl. No.: 19/055,203

(22) Filed: Feb. 17, 2025

(51) Int. Cl. B65D 43/02; B31B 50/59; B31B 120/10; B65D 1/34

(52) U.S. Cl. CPC B65D 43/0212; B31B 50/59; B65D 1/34; B31B 2120/10; B65D 2543/00194; B65D 2543/00305; B65D 2543/00527; B65D 2543/00537; B65D 2543/00648; B65D 2543/00685; B65D 2543/00731; B65D 2543/00805

(57) ABSTRACT

A lid and a dish for a palm leaf container is provided. The lid includes an upper surface and a downstanding lip. The downstanding lip includes one or more protrusions arranged thereon. The dish includes an upper flange, a bottom surface, and a side surface connecting the upper flange to the bottom surface. The lid and the dish are invertible to allow for the lid to be used as a dish, and the dish to be used as a lid.

### BACKGROUND

### Field

Example aspects described herein relate generally to containers for housing food, and more particularly to a palm leaf container comprising a dish and a lid.

### Related Art

As used herein, a dish is anything that is used to prepare, serve, or eat a meal. Example dishes include a plate, bowl, saucer, platter, vessel, tray, or similar container.

It is known to use containers for packaging and transporting all types of food-related goods. The food is oftentimes placed inside so called “takeaway” containers for storage and transporting (also interchangeably referred to as “to-go” or “meal-kit” containers). Sometimes dishes are placed wholly within such containers. Containers are typically made of aluminum, polypropylene (plastic), polystyrene (STYROFOAM) or of a compostable-type material such as wheat, sugarcane, balsa wood, palm leaf and paper, to name a few. Billions of such containers are used each year.

Typical polypropylene containers have desirable properties. They are durable, lightweight, waterproof, versatile, and cost effective. Polypropylene containers also have the desirable property of being able to be sealed such that the contents within the containers is unable to escape the bounds of the container. This is beneficial, for example, in cases where a user of the container is transporting a container from a restaurant to a place where the user plans to consume the food.

In some examples, polypropylene containers are manufactured from molds and can be designed with precise tolerances. Because of these precise tolerances with which polypropylene containers can be designed, components of the container can be manufactured with sealing features that mate with other components of the container. In some examples these sealing features include screw caps, snap-on lids, press-on seals, and flexible hinges.

However, polypropylene containers by far have the biggest environmental impacts. Of the millions of metric tons of packaging made of polypropylene produced globally each year, a relatively small fraction of it is recycled. The problem is expected to get worse as people continue to consume more packaged foods, and continue to purchase meal-kit and take-out foods.

Compostable packaging is another type of packaging with a more minimal environmental impact. The major benefits to the environment that compostable packaging provide are numerous. Compostable packaging, require less carbon to produce, reduce the amount of waste sent to landfills, reduce levels of pollution in the air, groundwater, and soil, and provide the earth with life-promoting nutrients.

Palm leaves may be used as a material for producing compostable packaging. In some cases, palm leaf containers are made from palm leaves that have fallen from or are cut from palm trees. In some cases, after the palm leaves are harvested, they are dried and pressed into the shape of a container, such as a plate or a bowl. Palm leaf containers are known to have some amount of natural variation due to the variation in characteristics of the palm leaves from which they are made. Likewise, environmental conditions such as the humidity and temperature can impact the drying and pressing of the leaves, which can lead to slight differences in the size and shape of the produced containers.

In some examples, due to the natural variation in the components of palm leaf containers, it is difficult to manufacture the containers such that they include a lit that can be mechanically coupled to bowl or a plate of the container. Likewise, it may also be difficult to include a seal for keeping the contents of such a container within an enclosed space of the container.

### SUMMARY

The example embodiments described herein meet the above-identified needs by providing an improved lid for securing to a dish of a palm leaf container.

One aspect of the disclosure is a palm leaf container comprising a palm leaf dish including an upper flange, a side surface, and a bottom surface. The side surface connects the upper flange and the bottom surface. The palm leaf container further comprises a palm leaf lid including an upper surface and a downstanding lip. The downstanding lip includes a plurality of protrusions arranged thereon. The palm leaf lid is configured to be coupled to the palm leaf dish such that a portion of the upper flange of the palm leaf dish is received within a cavity formed between one of the plurality of protrusions, the downstanding lip, and the upper surface of the palm leaf lid.

Another aspect of the disclosure is a method of making a palm leaf container. The method comprises placing a palm leaf lid of a container on a fixture of a protrusion press. The palm leaf lid comprises an upper surface and a downstanding lip. The protrusions press comprises one or more cylinders arranged thereon. The fixture comprises an outer surface and one or more piston receiving holes configured to receive a piston of one of the one or more cylinders. The method further comprises inserting a piston of one or more cylinders into the downstanding lip of the palm leaf lid. The method further comprises holding the piston of the one or more cylinders in the downstanding lip of the palm leaf lid. The method further comprises removing the piston of one or more cylinders from the downstanding lip of the palm leaf lid.

### BRIEF DESCRIPTION OF THE DRAWINGS

FIG. 1 is a perspective view of an example container.

FIG. 2 is a perspective view of another example container.

FIG. 3 is a perspective view of an example lid of the container of FIG. 1.

FIG. 4 is a cross-sectional view of the lid of FIG. 3.

FIG. 5 is a detail perspective view of the lid of FIG. 3.

FIG. 6 is a cross-sectional view of another example lid.

FIG. 7 is a detail perspective view of the lid of FIG. 6.

FIG. 8 is a side view of an example dish of the container of FIG. 1.

FIG. 9 is a cross-sectional view of the dish of FIG. 8.

FIG. 10 is a detail view of the dish of FIG. 8.

FIG. 11 is a flowchart describing an example method of securing the lid of FIG. 3 to the dish of FIG. 8.

FIG. 12 is a cross-sectional side view of the lid of FIG. 3 arranged over the dish of FIG. 8.

FIG. 13 is a cross-sectional side view of protrusions of the lid of FIG. 3 pushed against an upper surface of an upper flange of the dish of FIG. 8.

FIG. 14 is a cross-sectional side view of the protrusions of the lid of FIG. 3 being slid along an outer surface of the upper flange of the dish of FIG. 8.

FIG. 15 is a cross-sectional side view of the protrusions of the lid of FIG. 3 being allowed to secure under a lower surface of the upper flange of the dish of FIG. 8.

FIG. 16 is a perspective view of the container of FIG. 1 showing the lid of FIG. 3 secured to the dish of FIG. 8.

FIG. 17 is a flowchart describing an example method of removing the lid of FIG. 3 from the dish of FIG. 8.

FIG. 18 is a cross-sectional view of the protrusions of the lid of FIG. 3 being pushed against the lower surface of the upper flange of the dish of FIG. 8.

FIG. 19 is a cross-sectional view of the protrusions of the lid of FIG. 3 being slid along the outer surface of the upper flange of the dish of FIG. 8.

FIG. 20 is a cross-sectional view of the protrusions of the lid of FIG. 3 being allowed to move over the upper surface of the upper flange of the dish of FIG. 8.

FIG. 21 is a cross-sectional view of the lid of FIG. 3 being removed from the dish of FIG. 8.

FIG. 22 is a perspective view of an example protrusion press.

FIG. 23 is a side view of an example cylinder of the protrusion press of FIG. 22.

FIG. 24 is a perspective view of an example fixture of the protrusion press of FIG. 22.

FIG. 25 is a flowchart describing an example method of manufacturing the lid of FIG. 3.

FIG. 26 is a perspective view of a user pushing an example base lid onto the fixture of FIG. 24.

FIG. 27 is a perspective view of pistons of a plurality of cylinders of FIG. 23 of the protrusion press of FIG. 22 being inserted into the base lid of FIG. 26.

FIG. 28 is a perspective view of the base lid of FIG. 26 with the pistons removed therefrom.

FIG. 29 is a perspective view of a user removing the example base lid from the fixture of FIG. 24.

### DESCRIPTION

Aspects of the embodiments described herein provide a container with an improved lid and dish construction or assembly and methods of making the same.

In some examples, the container is made of palm leaves. Palm leaf containers are known to provide a smaller environmental impact than other forms of packaging. In some cases, palm leaf containers are made from palm leaves that have fallen from or are cut from palm trees. In some cases, after the palm leaves are harvested, they are dried and pressed into the shape of a container, such as a plate or a bowl. In some embodiments, components of palm leaf containers, such as a dish and/or a lid, are made in substantial part from the base, cushion, keel and stalk of abscised fronds. Palm leaf containers are known to have some amount of natural variation due to the variation in characteristics of the palm leaves from which they are made. Likewise, environmental conditions such as the humidity and temperature can impact the drying and pressing of the leaves, which can lead to slight differences in the size and shape of the produced containers. While certain figures herein depict a surface texture of the container intended to resemble a palm leaf, products corresponding to the embodiments described in the specification may have variations in palm leaf texture—including but not limited to streaking, shading, coloring, bubbles, patination, or other natural variations. The palm leaf texture depicted in the embodiments is for illustrative purposes only and should not limit the scope of protection. Accordingly, although the figures show a particular palm leaf texture, those skilled in the art should recognize that the scope of protection is not limited to the particular palm leaf texture and product design shown in the figures. Such variations in palm leaf texture of the products corresponding to the embodiments described in the specification are intended to be within the claimed scope of protection.

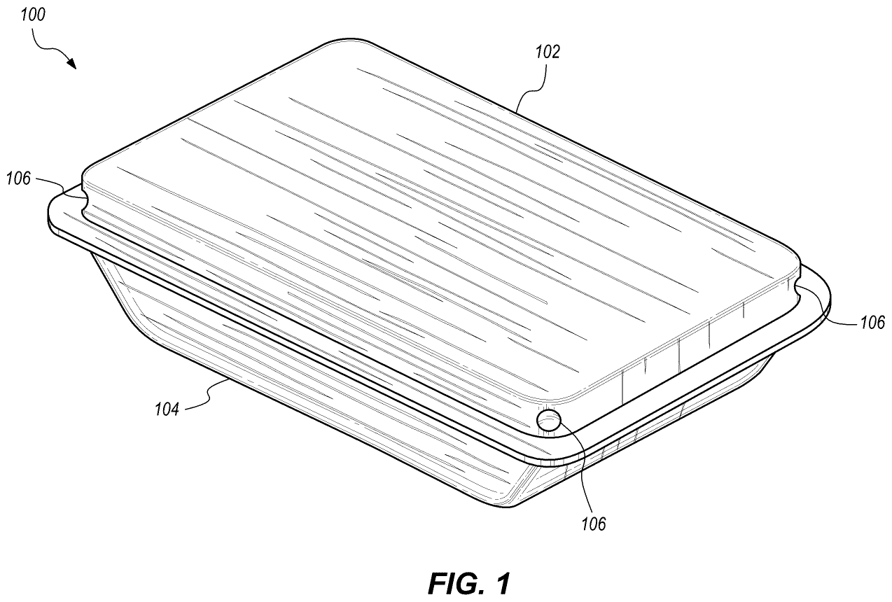

FIG. 1 is a perspective view of a container 100. The container 100 includes a lid 102 and dish 104. The lid 102 is arranged on top of the dish 104 such that the lid 102 covers an interior cavity of the dish 104. In some examples, the lid 102 also includes an interior cavity and when the lid 102 is arranged over the dish 104, the interior cavity of the lid 102 and the interior cavity of the dish 104 form an enclosed space within the container 100.

One or more portions of the container 100 is made in substantial part from one or more palm leaves. For example, the lid 102 is made from one or more palm leaves and the dish 104 is made from one or more palm leaves. The one or more palm leaves comprise the base, cushion, keel and stalk of abscised fronds.

In some examples, the lid 102 includes one or more protrusions 106. The protrusions 106 function to secure the lid 102 in place over the dish 104. The protrusions 106 are constructed to provide a mechanical coupling upon mating with a complementary component. In an example implementation, the complementary component can be a complementary recess. In another example implementation, the complementary component can be a complementary depression. In yet another example implementation, the complementary component can be a complementary flange. In some examples, one or more of the protrusions 106 of the lid 102 engage with the dish 104 to keep the lid 102 in position. As shown in FIG. 1, in some examples, one side of the protrusions 106 is a dimple (e.g., a recess, depression, indentation, groove, and the like), while the other side of the protrusions 106 is a projection that extends outwards (e.g., a boss, nub, bump, knob, and the like). In some examples, the protrusions 106 are formed from palm leaf. In some examples, the dimples on one side of the protrusions 106 are formed from palm leaf. In some examples, the protrusions and/or the dimples on one side of the protrusions 106 are formed from another material.

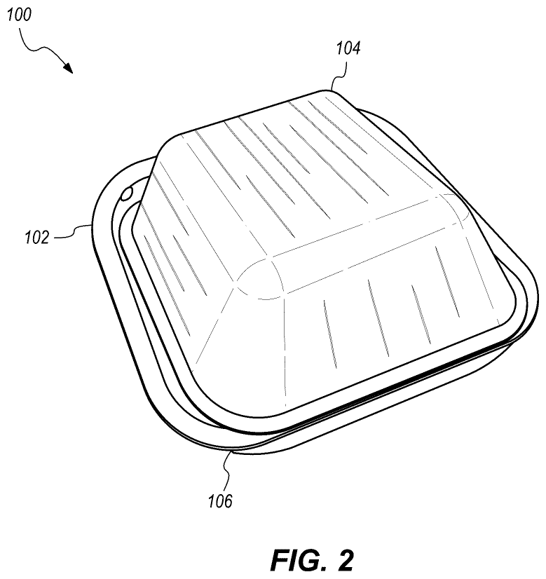

FIG. 2 is a perspective view of another the container 100 of FIG. 1 in an alternate configuration. In the alternate configuration of FIG. 2, the container 100 is flipped such that the lid 102 is configured to be used as a plate and the dish 104 is configured to be used as a lid. Thus, in the alternate configuration of FIG. 2, the dish 104 is arranged on top of the lid 102.

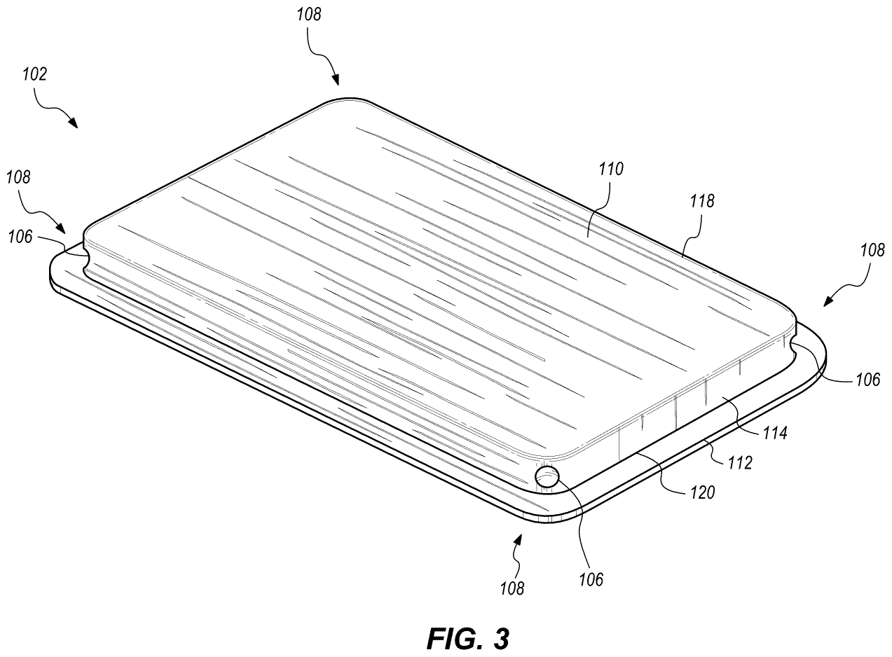

FIG. 3 is a perspective view of the lid 102 of FIG. 1. In some examples, the lid 102 includes an upper surface 110, a lower flange 112, and a downstanding lip 114. The upper surface 110 is connected to the lower flange 112 by the downstanding lip 114. In some examples, the upper surface 110 is connected to the downstanding lip 114 by an upper edge 118. In some examples, the downstanding lip 114 is connected to the lower flange 112 by a lower edge 120. In some examples, the upper surface 110 may include undulations due to the palm leaf material from which the upper surface 110 is made.

The upper surface 110 is substantially planar. In the example of FIG. 2, the upper surface 110 is rectangular shaped, however, in other examples, the upper surface 110 is formed into other shapes, such as, for example, a circle, a triangle, square, or a pentagon. In some embodiments, the other sections of the lid 102 (such as, for example, the upper edge 118 or lower flange 112) are formed correspondingly as a circle, triangle, pentagon, square, or pentagon.

In some examples, the upper edge 118 extends along a circumference of the upper surface 110. In some examples, the upper edge 118 is a sharp edge. In other examples, such as, for example, when the lid 102 is made from one or more palm leaves, the upper edge 118 is a rounded edge. A rounded edge, as used herein, generally refers to an edge that is curved or smoothed instead of being sharp or pointed. In some examples, the upper edge 118 extends between the upper surface 110 and the downstanding lip 114 and connects the upper surface 110 to the downstanding lip 114.

In some examples, the downstanding lip 114 includes one or more corners 108 and one or more protrusions 106. The downstanding lip 114 extends between the upper edge 118 and the lower flange 112. In some examples, as depicted in FIG. 3, the downstanding lip 114 extends vertically downward. In the example of FIG. 3, each side of the downstanding lip 114 is arranged perpendicular to the upper surface 110 and/or the lower flange 112. In other examples, the downstanding lip 114 is angled downward. In some examples, portions of the downstanding lip 114 that are arranged along sides of the upper surface 110 are substantially planar.

In some examples, portions of the downstanding lip 114 includes corners 108 that are arranged adjacent to corners of the upper surface 110. In some examples, such as the example of FIG. 3, the downstanding lip 114 includes four corners 108, with each corner 108 being arranged adjacent a corresponding corner of the rectangular upper surface 110 and extending from the upper surface 110 to the lower edge 120.

In some examples, the downstanding lip 114 includes one or more protrusions 106 formed thereon. In some examples, such as the example of FIG. 3, the protrusions 106 are formed on each corner 108 of the downstanding lip 114. Thus, the lid 102 includes four protrusions 106, with one protrusion 106 formed on each corner 108 of the downstanding lip 114. In other examples, the protrusions 106 are formed on the planar sides of the downstanding lip 114.

Similar to the embodiment depicted in FIG. 1, the protrusions 106 are constructed to provide a mechanical coupling upon mating with a complementary component. In an example implementation, the complementary component can be a complementary recess. In another example implementation, the complementary component can be a complementary depression. In yet another example implementation, the complementary component can be a complementary flange. In some examples, one or more of the protrusions 106 of the lid 102 engage with the dish 104 to keep the lid 102 in position. As shown in FIG. 3, in some examples, one side of the protrusions 106 is a dimple (e.g., a recess, depression, indentation, groove, and the like), while the other side of the protrusions 106 is a projection that extends outwards (e.g., a boss, nub, bump, knob, and the like).

In some examples, the lower edge 120 extends along a circumference of the downstanding lip 114. In some examples, the lower edge 120 is a sharp edge. In other examples, such as, for example, when the lid 102 is made from one or more palm leaves, the lower edge 120 is a rounded edge. In some examples, the lower edge 120 extends between the downstanding lip 114 and the lower flange 112 and connects the downstanding lip 114 to the lower flange 112.

In some examples, the lower flange 112 extends out from the downstanding lip 114. In some examples, the lower flange 112 is substantially planar. In some examples, such as when the lid 102 is formed from one or more palm leaves, the lower flange 112 includes one or more undulations arranged thereon.

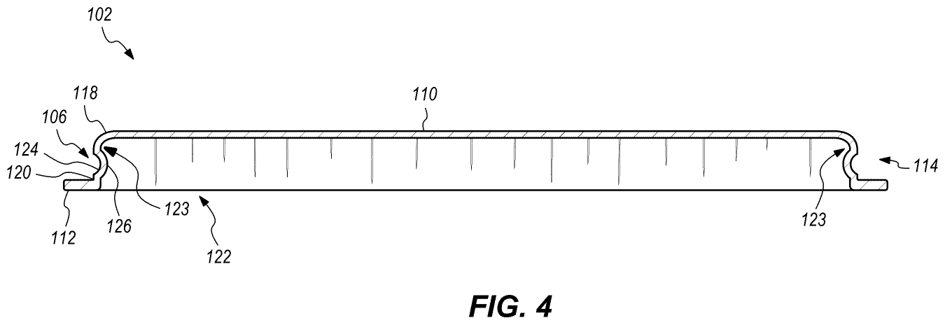

FIG. 4 is a cross-sectional side view of the lid 102 of FIG. 3. In some examples, the lid 102 further includes an upper cavity 122. In some examples, the upper cavity 122 is formed by the upper surface 110 and the downstanding lip 114.

In some examples, as shown in the example of FIG. 4, when the upper cavity 122 is formed within the lid 102, the protrusions 106 formed in the downstanding lip 114 of the lid 102 include both an outer surface 124 and an inner surface 126. In some examples, the inner surface 126 of the protrusions 106 is formed adjacent the upper cavity 122 of the lid 102. In some examples, the inner surface 126 of the protrusions 106 protrudes into the upper cavity 122 of the lid 102. In some examples, the outer surface 124 of a protrusion 106 is formed as a concave indentation. In some examples, the inner surface 126 of the protrusion 106 is formed as a convex indentation. In some examples, the convex indentation of each of the protrusions 106 are approximately one millimeter deep (such as one millimeter deep). In some examples, the convex indentation of each of the protrusions 106 are between approximately one millimeter deep and approximately two millimeters deep. In other examples, the convex indentation of each of the protrusions 106 are approximately one half of a millimeter deep (such as one half of a millimeter). In some examples, the convex indentation of each of the protrusions 106 are between approximately one millimeter deep and approximately one half of a millimeter deep. In some examples, the depth of the convex indentation of each protrusions 106 is measured from an outer side of the downstanding lip 114 to the innermost point on the outer surface 124 of the protrusion 106.

In some examples, the lid 102 further includes a securing cavity 123. In some examples, the securing cavity 123 is part of the upper cavity 122 of the lid 102 and is formed in between the inner surface 126 of each protrusion 106, the downstanding lip 114, and the upper surface 110 of the lid 102. In some examples, the number of securing cavities 123 of the lid 102 is equal to the number of protrusions 106 arranged on the downstanding lip 114. In some examples, the lid 102 includes four protrusions 106, with one protrusion 106 arranged at each corner 108 of the downstanding lip 114 and four securing cavities 123, with one securing cavity 123 being arranged at each corner 108 of the downstanding lip 114 between in inner surface 126 of each protrusion 106 and the upper surface 110 of the lid 102.

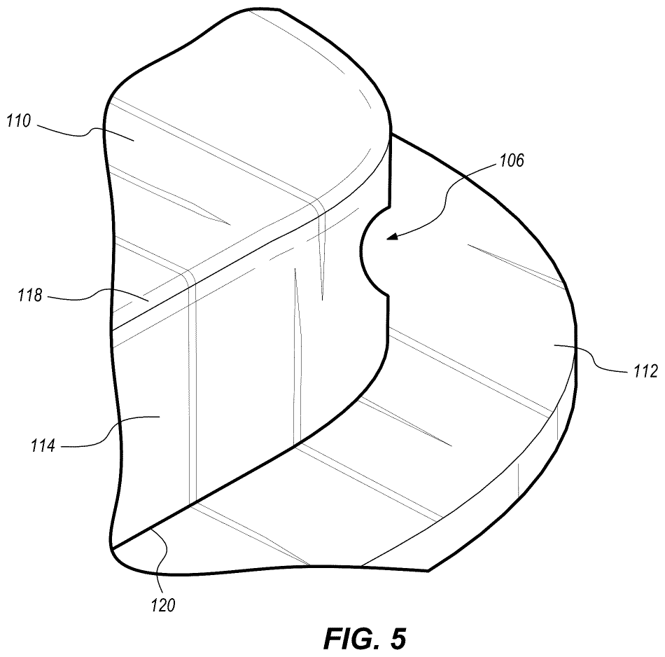

FIG. 5 is a perspective view of a corner 108 of the downstanding lip 114 of the lid 102. In the example of FIG. 5, the lid 102 includes a protrusion 106 formed on the corner 108 of the downstanding lip 114. The protrusion 106 is formed an indentation on the surface of the downstanding lip 114.

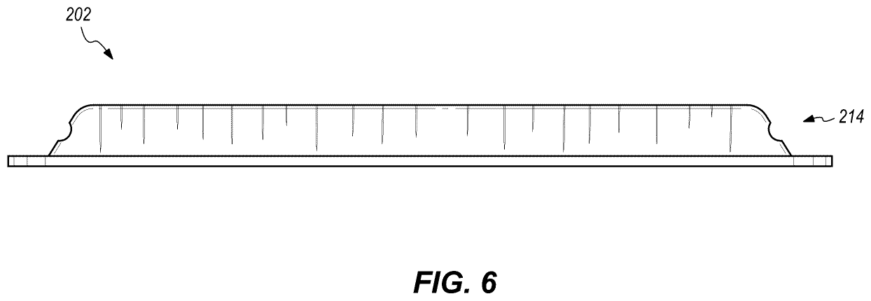

FIG. 6 is a cross-sectional side view of another example lid 202 that can be used with the example container 100 of FIGS. 1-2. In some examples, the lid 202 is formed substantially similarly to the lid 102 and includes one or more of the components of the lid 102 described with reference to FIGS. 3-5. In some examples, the lid 102 includes a downstanding lip 214, however, unlike the downstanding lip 114 of the lid 102, the downstanding lip 214 is angled with respect to an upper surface 210 of the lid 202.

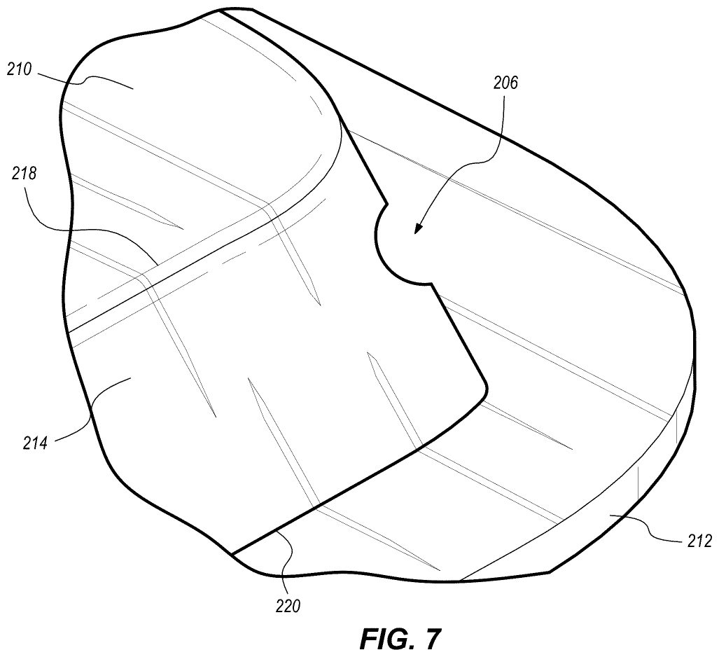

FIG. 7 is a perspective view of a corner 208 of the downstanding lip 214 of the lid 202. In the example of FIG. 7, the lid 202 includes a protrusion 206 formed on a corner 208 of the downstanding lip 214. The protrusion 106 is formed an indentation on the surface of the downstanding lip 214.

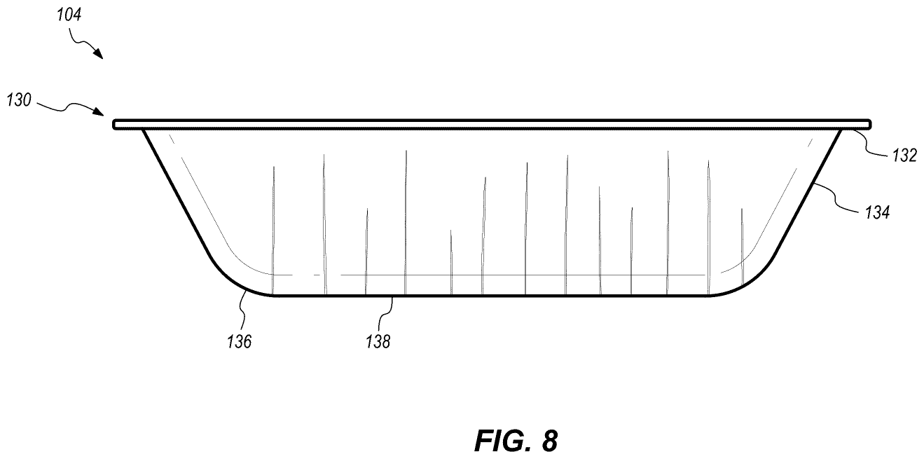

FIG. 8 is a side view of the dish 104 of FIG. 1. The dish 104 includes an upper flange 130, an upper edge 132, a side surface 134, a lower edge 136, and a bottom surface 138. The bottom surface 138 is connected to the upper flange 130 by the side surface 134. In some examples, the bottom surface 138 is connected to the side surface 134 by a lower edge 136. In some examples, the side surface 134 is connected to the upper flange 130 by the upper edge 132. In some examples, the bottom surface 138 surface may include undulations due to the palm leaf material from which the bottom surface 138 is made.

The bottom surface 138 is substantially planar. In the example of FIG. 8, the bottom surface 138 is rectangular shaped, however, in other examples, the bottom surface 138 is formed into other shapes, such as, for example, a circle, a triangle, or a pentagon. In some examples, the shape of the bottom surface 138 matches the shape of the upper surface 110 of the lid 102.

In some examples, the lower edge 136 extends along a circumference of the bottom surface 138. In some examples, the lower edge 136 is a sharp edge. In other examples, such as, for example, when the dish 104 is made from one or more palm leaves, the lower edge 136 is a rounded edge. In some examples, the lower edge 136 extends between the bottom surface 138 and the side surface 134 and connects the bottom surface 138 side surface 134.

In some examples, the side surface 134 includes one or more corners. The side surface 134 extends between the lower edge 136 and the upper flange 130. In some examples, the side surface 134 extends vertically upward from the bottom surface 138. In such examples, each side of the side surface 134 is arranged perpendicular to the bottom surface 138 and/or the upper flange 130. In other examples, such as the example of FIG. 8, the side surface 134 is angled upward. In some examples, portions of the side surface 134 that are arranged along sides of the bottom surface 138 are substantially planar.

In some examples, portions of the side surface 134 includes corners that are arranged adjacent to corners of the bottom surface 138. In some examples, such as the example of FIG. 8, the side surface 134 includes four corners, with each corner being arranged adjacent a corresponding corner of the rectangular bottom surface 138 and extending from the bottom surface 138 to the upper edge 132.

In some examples, the upper edge 132 extends along a circumference of the side surface 134. In some examples, the upper edge 132 is a sharp edge. In other examples, such as, for example, when the dish 104 is made from one or more palm leaves, the upper edge 132 is a rounded edge. In some examples, the upper edge 132 extends between the side surface 134 and the upper flange 130 and connects the side surface 134 to the upper flange 130.

In some examples, the upper flange 130 extends out from the side surface 134. In some examples, the upper flange 130 is substantially planar. In some examples, such as when the dish 104 is formed from one or more palm leaves, the upper flange 130 includes one or more undulations arranged thereon.

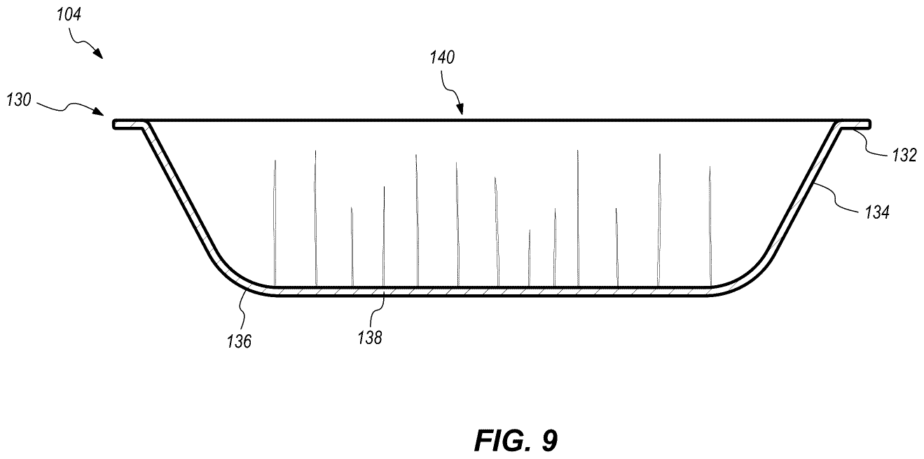

FIG. 9 is a side cross-sectional side view of the dish 104 of FIG. 8. In some examples, the dish 104 further includes a lower cavity 140. In some examples, the lower cavity 140 is formed by the bottom surface 138 and the side surface 134.

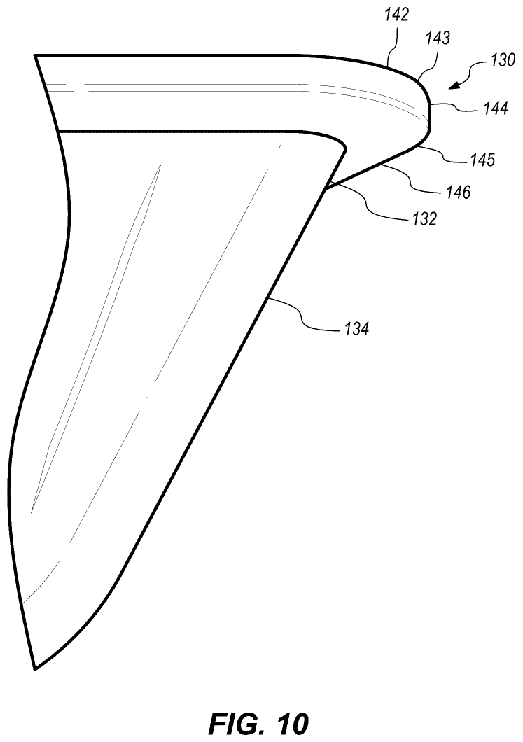

FIG. 10 is a detail view of a portion of the dish 104 of FIG. 8. In some examples, the upper flange 130 includes an upper surface 142, an outer surface 144, and a lower surface 146. In some examples, the upper flange 130 further includes an upper flange edge 143 and a lower flange edge 145. In some examples, the upper surface 142 and the lower surface 146 are parallel to each other and the outer surface 144 is perpendicular to the upper surface 142 and the lower surface 146. In some examples the outer surface 144 connects the upper surface 142 and the lower surface 146. In some examples, the upper flange edge 143 connects the upper surface 142 to the outer surface 144. In some examples, the lower flange edge 145 connects the lower surface 146 to the outer surface 144.

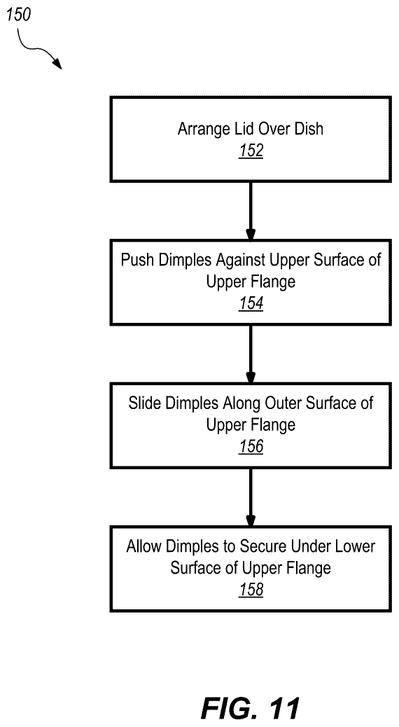

FIG. 11 depicts an example method 150 of securing the lid 102 to the dish 104. While the example method 150 is described herein with reference to the example lid 102, the method 150 may also be performed using the lid 202 and the dish 104. The method 150 includes operations 152, 154, 156, and 158. Operation 152 includes arranging the lid 102 over the dish 104. Operation 154 includes pushing the protrusions 106 against the upper flange 130. Operation 156 includes sliding the protrusions 106 along the outer surface 144 of the upper flange 130. Operation 158 includes allowing protrusions 106 to secure under the lower surface 146 of the upper flange 130.

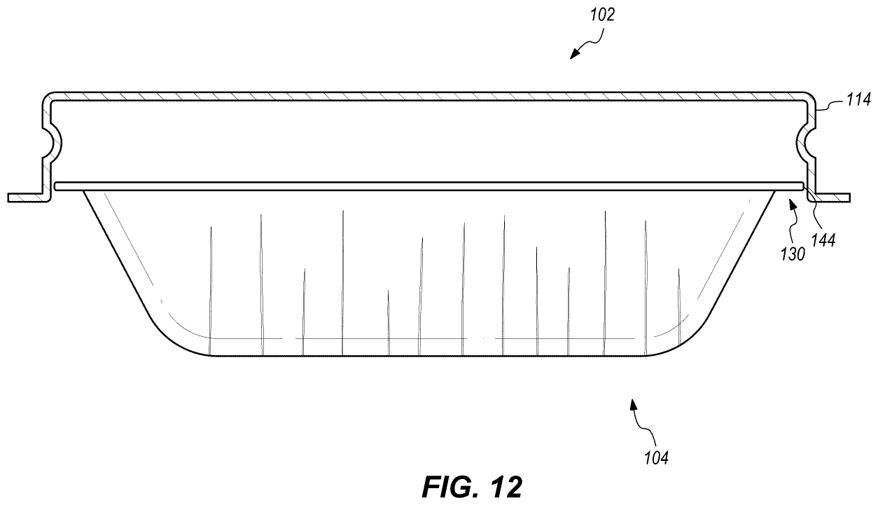

FIG. 12 is a cross-sectional side view of the container 100 during operation 152 of the method 150 of FIG. 11. As shown in FIG. 12, during operation 152 of the method 150 of FIG. 11, the lid 102 is arranged over the dish 104. In some examples, in operation 152, the downstanding lip 114 is arranged around the outer surface 144 of the upper flange 130 such that the upper flange 130 is inserted into an opening of the lid 102 formed by the downstanding lip 114.

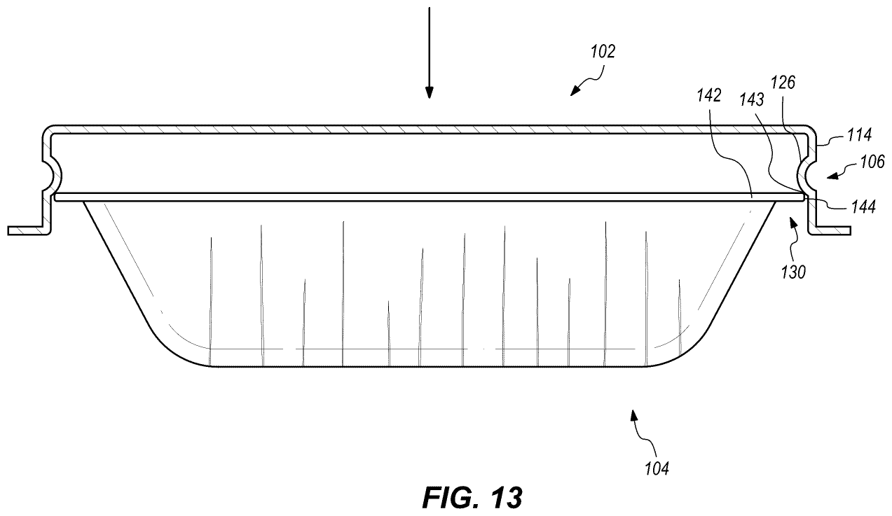

FIG. 13 is a cross-sectional side view of the container 100 during operation 154 of the method 150 of FIG. 11. As shown in FIG. 13, during operation 154 of the method 150 of FIG. 11, the protrusions 106 are pushed against the upper surface 142 of the upper flange 130. In the example of FIG. 13, the lid 102 is pushed onto the dish 104. As the lid 102 is pushed onto the dish 104, the protrusions 106 of the downstanding lip 114 of the lid 102 are placed into contact with the upper flange 130 of the dish 104. Specifically, the inner surface 126 of the protrusions 106 contacts the upper surface 142 of the upper flange 130. In some examples, as the lid 102 is pushed into the dish 104, the rounded convex inner surface 126 of the protrusions 106 contacts the upper flange edge 143 of the upper flange 130. The continued force applied to the lid 102 causes the lid 102 to flex, which allows the inner surface 126 of the protrusions 106 to travel over the upper flange edge 143 and contact the outer surface 144 of the upper flange 130.

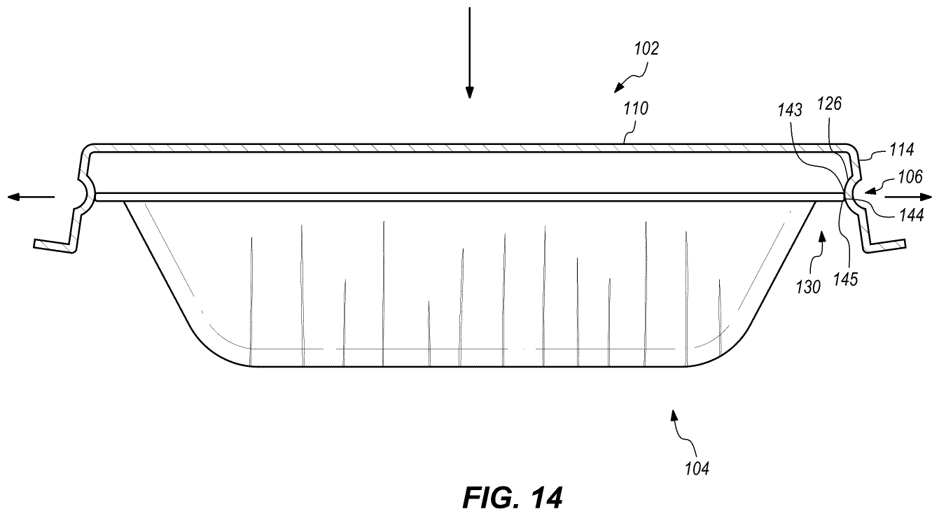

FIG. 14 is a cross-sectional side view of the container 100 during operation 156 of the method 150 of FIG. 11. As shown in FIG. 14, during operation of 156 of the method 150 of FIG. 11, the protrusions 106 are slid along the outer surface 144 of the upper flange 130. FIG. 14 depicts the lid 102 in a flexed configuration with the inner surface 126 of the protrusions 106 contacting the outer surface 144 of the upper flange 130. In some examples, as force is applied to the lid 102, the inner surface 126 of the protrusions 106 slides along the outer surface 144 of the upper flange 130 from the upper flange edge 143 to the lower flange edge 145.

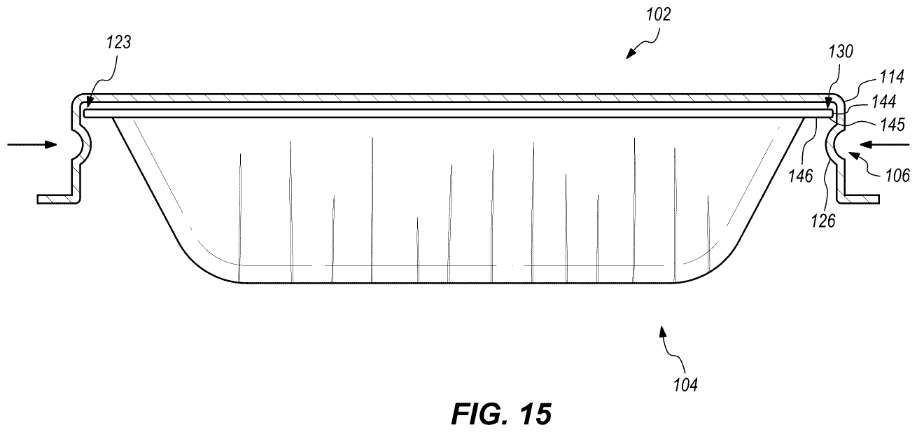

FIG. 15 is a cross-sectional side view of the container 100 during operation 158 of the method 150 of FIG. 11. During operation 158 of the method 150 of FIG. 11, the protrusions 106 are slid past the lower flange edge 145 of the upper flange 130 and are allowed to secure under the lower surface 146 of the upper flange 130. In some examples, the inner surface 126 of the protrusions 106 moves along the lower flange edge 144 as the lid 102 is pushed into the dish 104. As the inner surface 126 of the protrusions 106 moves along the lower flange edge 144, the lid 102 flexes back into an unflexed configuration. As the lid 102 flexes back into the unflexed configuration, the inner surface 126 of the protrusions 106 moves into position below the lower surface 146 of the upper flange 130. In some examples, the positioning of the protrusions 106 below the lower surface 146 of the upper flange 130 secures the lid 102 in place onto the dish 104. In some examples, due to the arrangement of the protrusions 106 below the lower surface 146 of the upper flange 130, the container 100 may be dropped by a user and the lid 102 will remain in place on the dish 104. In some examples, the positioning of the protrusions 106 below the lower surface 146 of the upper flange 130 locks the upper flange 130 into position into the securing cavity 123 formed between each of the protrusions 106, the downstanding lip 114, and the upper surface 110 of the lid 102.

In some examples, the protrusions 106 are arranged on the downstanding lip 114 at a first distance below the upper surface 110 of the lid 102. In some examples, the first distance is greater than a distance between the upper surface 142 and the lower surface 146 of the upper flange 130 of the dish 104. In some examples, by arranging the protrusions 106 at such a distance from the upper surface 110, the upper flange 130 of the dish 104 is able to be accommodated within the securing cavity 123 of the lid 102. In some examples, the protrusions 106 are arranged on the downstanding lip 114 sufficiently below the upper surface 110 of the lid 102 to accommodate the upper flange 130 of the dish 104 within the securing cavity 123 even when the upper flange 130 of the dish 104 varies in thickness or includes undulations arranged thereon.

In some examples, the lid 102 is sized such that when the upper flange 130 of the dish 104 is accommodated within the securing cavity 123, there is a space between an underside of the upper surface 142 of the upper flange 130 and the upper surface 110 of the lid 102. In other examples, one or more portions of the upper surface 142 of the upper flange 130 contact the underside of the upper surface 110 of the lid 102. In some examples, due to undulations on the upper flange 130 of the lid 102, some portions of the upper surface 142 of the upper flange 130 contact the underside of the upper surface 110 of the lid 102 while other portions of the upper surface 142 of the upper flange 130 do not contact the underside of the upper surface 110 of the lid 102.

In some examples, the lid 102 is sized such that when the upper flange 130 of the dish 104 is accommodated within the securing cavity 123, there is a space between an inner surface of the downstanding lip 114 of the lid 102 and the outer surface 144 of the upper flange 130 of the dish 104. In other examples, one or more portions of the outer surface 144 of the upper flange 130 contact the inner side of the downstanding lip 114 of the lid 102. In some examples, due to undulations on or variations in the width on the upper flange 130 of the lid 102, some portions of the outer surface 144 of the upper flange 130 contact the inner surface of the downstanding lip 114 of the lid 102 while other portions of the outer surface 144 of the upper flange 130 do not contact the outer surface 144 of the upper flange 130 of the lid 102.

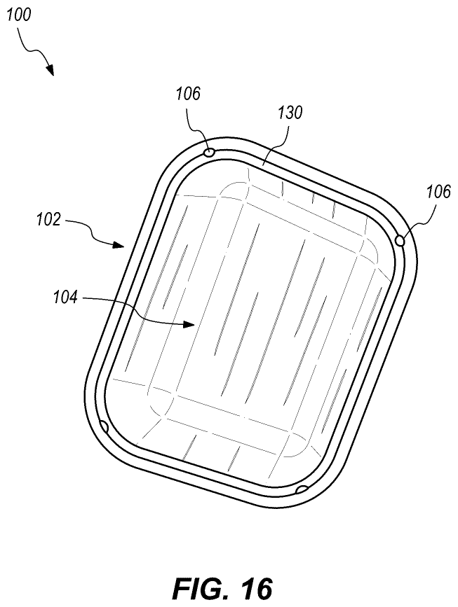

FIG. 16 is a lower perspective view of the example container 100 in a fully assembled state after the method 150 of FIG. 11 is complete. As described above, when in the fully assembled state, the lid 102 is secured over the dish 104 such that the upper flange 130 of the dish 104 is secured within the securing cavity 123 of the lid 102. In some examples, the upper flange 130 of the dish 104 is secured within four securing cavities 123 of the lid 102, with one securing cavity 123 being arranged at each corner 108 of the lid 102.

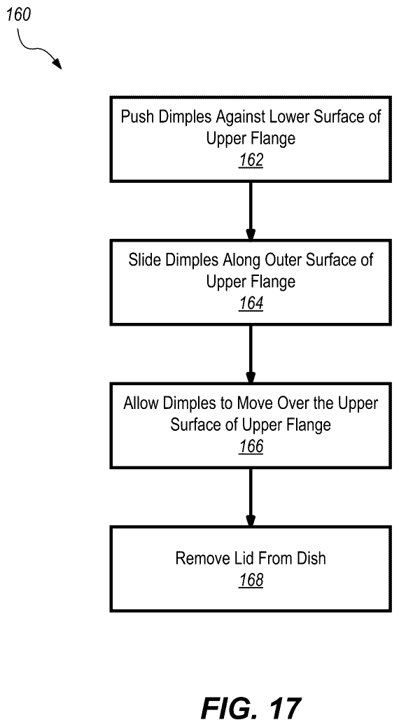

FIG. 17 depicts an example method 160 of removing the lid 102 from the dish 104. While the example method 160 is described herein with reference to the example lid 102, the method 160 may also be performed using the lid 202 and the dish 104.

The method 160 includes operations 162, 164, 166, and 168. Operation 162 includes pushing the protrusions 106 against the lower surface 146 of the upper flange 130. Operation 164 includes sliding the protrusions 106 along the outer surface 144 of the upper flange 130. Operation 166 includes allowing the protrusions 106 to move over the upper surface 142 of the upper flange 130. Operation 168 includes removing the lid 102 from the dish 104.

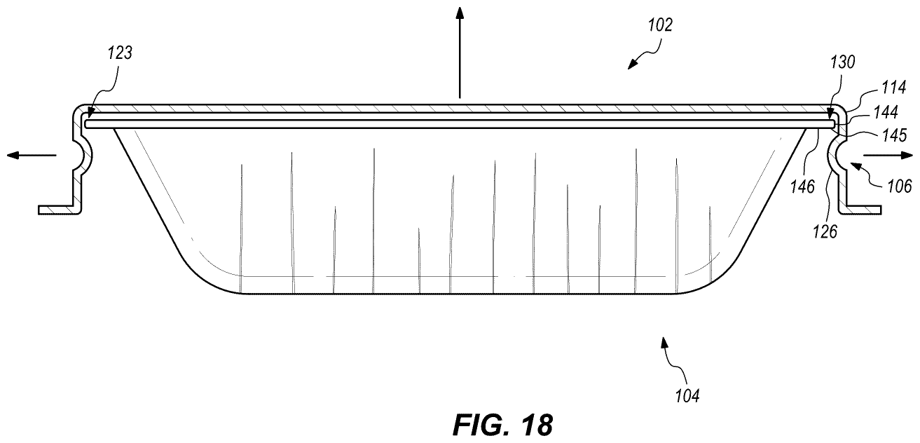

FIG. 18 is a cross-sectional side view of the container 100 during operation 162 of the method 150 of FIG. 17. As shown in FIG. 18, during operation 162 of the method 160 of FIG. 17, the protrusions 106 are pushed against the lower surface 146 of the upper flange 130. In the example of FIG. 18, the lid 102 is pushed off of the dish 104. As the lid 102 is pushed off of the dish 104, the protrusions 106 of the downstanding lip 114 of the lid 102 are placed into contact with the upper flange 130 of the dish 104. Specifically, the inner surface 126 of the protrusions 106 contacts the lower surface 146 of the upper flange 130. In some examples, as the lid 102 is pushed off of the dish 104, the rounded convex inner surface 126 of the protrusions 106 contacts the lower flange edge 145 of the upper flange 130. The continued force applied to the lid 102 causes the lid 102 to flex, which allows the inner surface 126 of the protrusions 106 to travel over the lower flange edge 145 and contact the outer surface 144 of the upper flange 130. As the inner surface 126 of the protrusions 106 travels over the lower flange edge 145 of the upper flange 130, the upper flange 130 is removed from the securing cavity 123 of the lid 102.

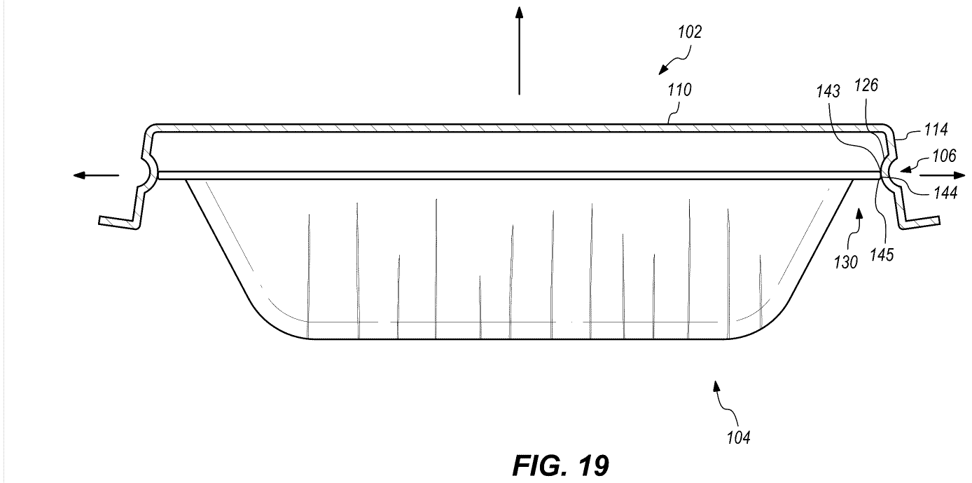

FIG. 19 is a cross-sectional side view of the container 100 during operation 164 of the method 160 of FIG. 17. As shown in FIG. 19, during operation of 164 of the method 160 of FIG. 17, the protrusions 106 are slid along the outer surface 144 of the upper flange 130. FIG. 19 depicts the lid 102 in a flexed configuration with the inner surface 126 of the protrusions 106 contacting the outer surface 144 of the upper flange 130. In some examples, as force is applied to the lid 102 to move the lid 102 away from the dish 104, the inner surface 126 of the protrusion 106 slides along the outer surface 144 of the upper flange 130 from the lower flange edge 145 to the upper flange edge 143.

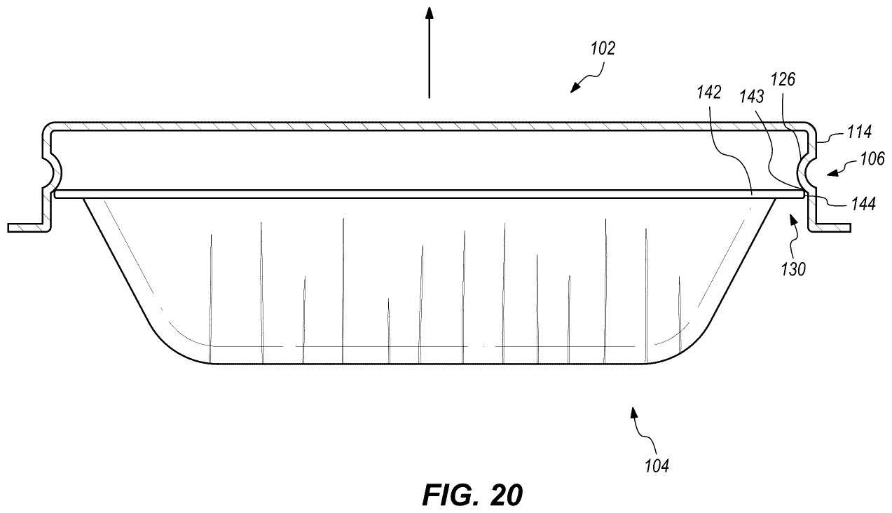

FIG. 20 is a cross-sectional side view of the container 100 during operation 166 of the method 160 of FIG. 17. During operation 166 of the method 160 of FIG. 17, the protrusions 106 are slid past the upper flange edge 143 of the upper flange 130 and are allowed to move over the upper surface 142 of the upper flange 130. In some examples, the inner surface 126 of the protrusions 106 moves along the upper flange edge 143 as the lid 102 is pushed away from the dish 104. As the inner surface 126 of the protrusions 106 moves along the upper flange edge 143, the lid 102 flexes back into an unflexed configuration. As the lid 102 flexes back into the unflexed configuration, the inner surface 126 of the protrusions 106 moves into position above the upper surface 142 of the upper flange 130.

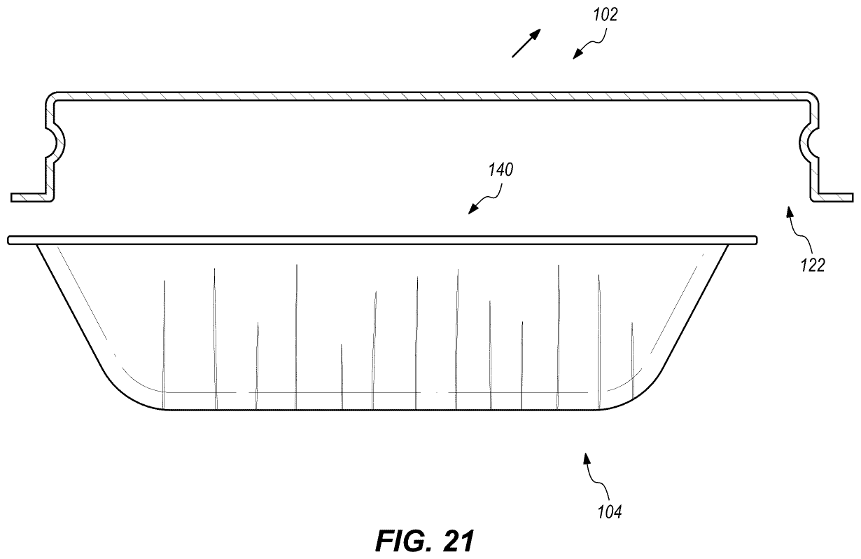

FIG. 21 is a cross-sectional side view of the container 100 during operation 168 of the method 160 of FIG. 17. During operation 168 of the method 160 of FIG. 17, the lid 102 is removed from the dish 104. In some examples, as the lid 102 is removed from the dish 104, the upper flange 130 of the dish 104 is removed from the upper cavity 122 of the lid 102 such that the lid 102 can be freely moved with respect to the dish 104. In some examples, removing the lid 102 from the dish 104 allows for the lower cavity 140 of the dish 104 to be made accessible to a user.

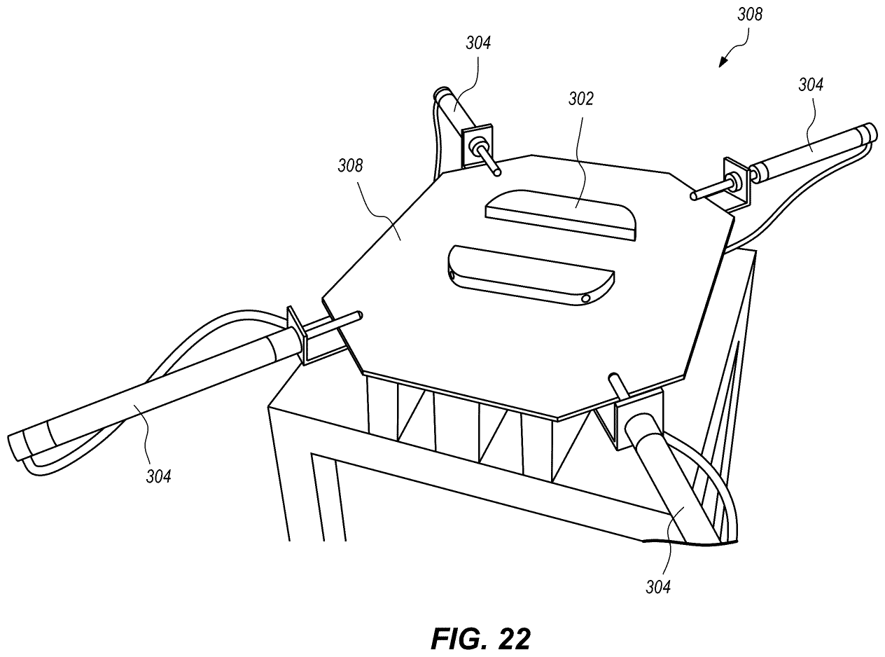

FIG. 22 depicts an example protrusion press 300 used to produce protrusions 106, 206 in a lid 102, 202. In some examples, the protrusion press 300 includes a base plate 308, a fixture 302, and one or more cylinders 304. In some examples, the protrusion press 300 further includes a control switch 306.

In some examples, as shown in the example of FIG. 22, the fixture 302 is mounted onto an upper surface of the base plate 308 and the cylinders 304 are arranged around the fixture 302. In some examples, the cylinders 304 are arranged circumferentially around the fixture 302. In some examples, the fixture 302 is centered on the base plate 308 and the cylinders 304 are arranged equidistant from the fixture 302.

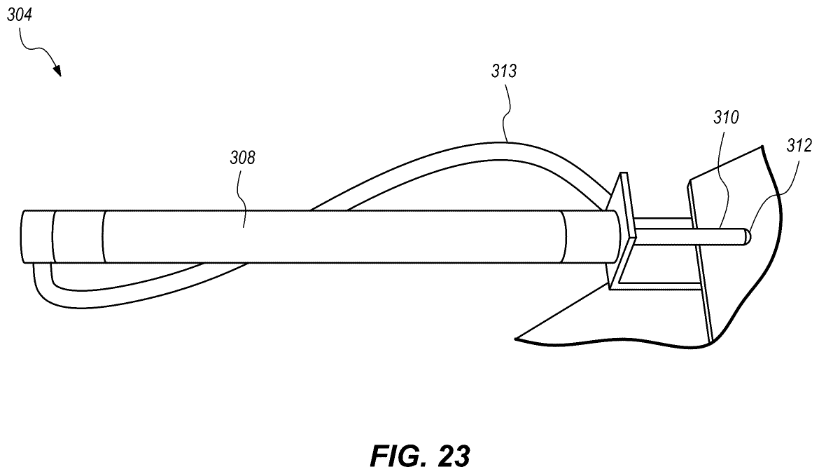

FIG. 23 is a side view of an example cylinder 304. In some examples, the cylinder 304 includes a barrel 308 and a piston 310 and one or more lines 313. In some examples the cylinder 304 comprises a hydraulic cylinder, a pneumatic cylinder, a hydropneumatics cylinder, a mechanical actuator, or a piezoelectric actuator. In some examples, the lines 313 are pneumatic or hydraulic lines that connect the barrel 308 to a pneumatic or a hydraulic pump.

In some examples, the cylinder 304 is adjustable between an extended position and a retracted position. In the retracted position, a portion of the piston 310 is housed within the barrel 308. In the extended position, the piston 310 extends out from the barrel 308. In some examples, the piston 310 includes a free end 312. In some examples, the free end 312 is rounded and convex in shape. In some examples, the free end 312 is complementary to the concave shape of the outer surface 124 of the protrusions 106.

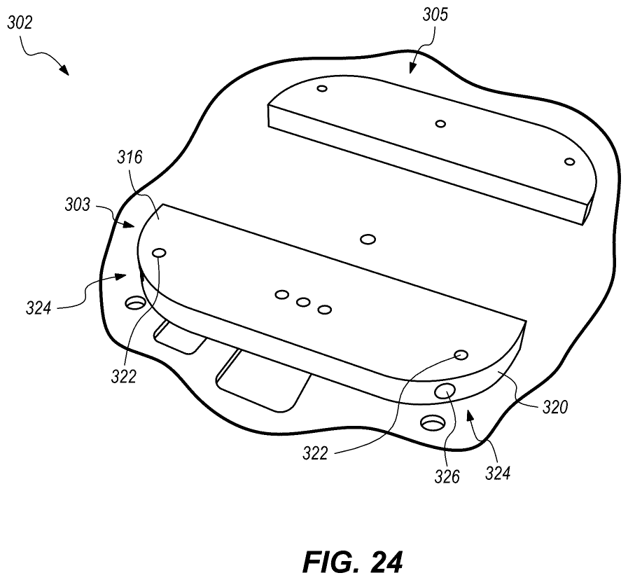

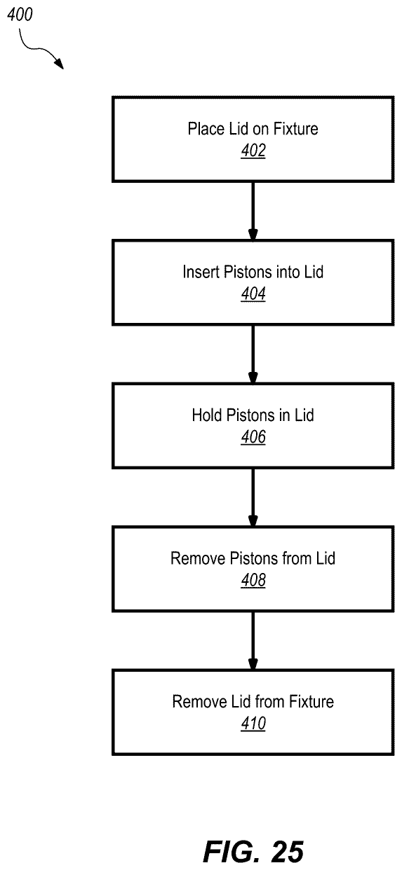

FIG. 24 is a perspective view of the fixture 302. In some examples, the fixture 302 includes a first portion 303 and a second portion 305. In some examples, the first portion 303 and the second portion 305 are connected. In other examples, such as the example of FIG. 25, the first portion 303 and the second portion 305 are formed as separate pieces of the fixture 302. In some such examples, the first portion 303 and the second portion 305 are shaped substantially similarly.

In some examples, the first portion 303 of the fixture 302 includes a top surface 316, a bottom surface 318, and an outer surface 320. In some examples, the first portion 303 of the fixture 302 includes one or more mounting holes 322 and one or more piston receiving holes 326.

In some examples, the top surface 316 and the bottom surface 318 are planar and parallel to one another. In some examples, the mounting holes 322 are formed in fixture 302 such that the mounting holes 322 extend through the top surface 316 and the bottom surface 318. In some examples, the top surface 316 and the bottom surface 318 of the fixture 302 are separated from each other by a first distance. In some examples, the first distance is approximately equal to the distance between the lower flange 112 and the upper surface 110 of the lid 102. In some examples, the first distance is less than the distance between the lower flange 112 and the upper surface 110 of the lid 102.

In some examples, the outer surface 320 extends between the top surface 316 and the bottom surface 318 of the first portion 303. In some examples, the outer surface 320 is perpendicular to the top surface 316 and the bottom surface 318. In other examples, the outer surface 320 is arranged at an angle between the top surface 316 and the bottom surface 318. In some examples, the outer surface 320 includes one or more corners. In some examples, the corners are formed as rounded corners 324. In some examples, the shape and location of the rounded corners 324 matches the shape and location of the corners 108 of the downstanding lip 114 of the lid 102.

In some examples, the piston receiving holes 326 are formed in the outer surface 320 of the first portion 303 and extend into the first portion 303 in a direction perpendicular to a plane of the outer surface 320 and/or parallel to the plane of the top surface 316. In some examples, the piston receiving holes 326 are formed in the outer surface 320 of the first portion 303 approximately half way between the bottom surface 318 and the top surface 316 of the fixture 302. In some examples, the piston receiving holes 326 are formed as protrusions and are concave with respect to the outer surface 320. In some examples, the concave shape of the piston receiving holes 326 is complementary in shape to the inner surface 126 of the protrusions 106. In some examples, the piston receiving holes 326 are formed on each of the rounded corners 324 of the fixture 302. Thus, in some examples, the fixture 302 comprises four piston receiving holes 326.

Referring generally to FIG. 22-24, in some examples, the fixture 302 is mounted onto the base plate 308 with the bottom surface 318 of the fixture 302 being place flush with a top surface of the base plate 308. Fasteners are extended through the mounting holes 322 and into the base plate 308 to secure the fixture 302 in place on the base plate 308. The outer surface 320 is arranged to face an outer edge of the base plate 308.

The cylinders 304 are mounted onto the base plate 308 such that the free end 312 of each cylinder 304 faces the fixture 302. In some examples, the barrel 308 of each cylinder 304 is mounted to the base plate 308. In some examples, the cylinders 304 are arranged such that the free end 312 of each cylinder 304 extends into the corresponding piston receiving hole 326 of the fixture 302 that it faces when moved into the extended position.

In some examples the control switch 306 is manipulated by a user to cause the cylinders 304 to move into the extended position. In some examples, when manipulated by a user, the control switch 306 causes each of the cylinders 304 to simultaneously move into the extended position. In some examples, the cylinders 304 remain in the extended position for a time interval. In some examples, the cylinders 304 automatically move back into the retracted position after the time interval. In some examples, the time period is approximately five seconds. In other examples, the cylinders 304 remain in the extended position for approximately ten seconds.

FIG. 25 depicts an example method 400 of manufacturing the lid 102 of FIG. 3. While the method 400 is described with reference to manufacturing the lid 102 of FIG. 3, the method 400 may also be used to manufacture the lid 202 of FIG. 6. In some examples, the method 400 is performed on a base lid 103 to produce the lid 102. In some examples, the base lid 103 is substantially the same as the lid 102 except that the base lid 103 does not contain protrusions 106. Similarly, in some examples, the method 400 is performed on a base lid 203 to produce the lid 202. In some examples, the base lid 203 is substantially similar to the lid 202 except that the base lid 203 does not contain protrusions 206.

The method 400 includes operations 402, 404, 406, 408, and 410. In some examples, the method 400 is Operation 402 includes placing a base lid 103 on the fixture 302. Operation 404 includes inserting the pistons 310 into base lid 103. Operation 406 includes holding the pistons 310 in the base. Operation 408 includes removing the pistons 310 from the base. Operation 410 includes removing the lid 102 from the fixture 302.

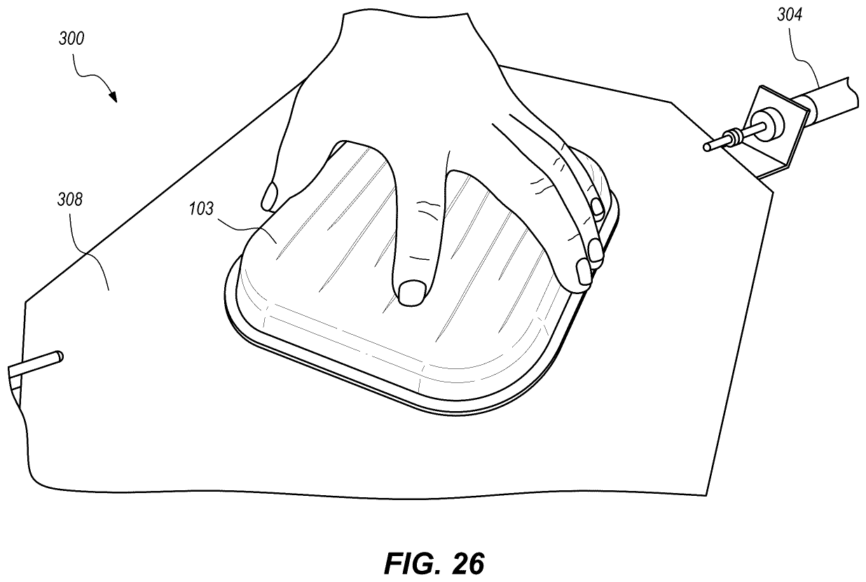

FIG. 26 is a perspective view of a base lid 103 placed onto the fixture 302 in operation 402 of the method 400 of FIG. 25. In some examples, the base lid 103 is placed onto the fixture 302 such that the upper surface 110 of the base lid 103 contacts the top surface 316 of the fixture 302. In some examples, when placed on the fixture 302, the downstanding lip 114 of the base lid 103 extends over the outer surface 320 of the fixture 302. In some examples, the corners 108 of the base lid 103 extend around the rounded corners 324 of the fixture 302. In some examples, when placed onto the fixture 302, the lower flange 112 of the lid 102 lies against the upper surface of the base plate 308. In some examples, a user of the protrusion press 300 presses the upper surface 110 of the base lid 103 onto the fixture 302 throughout the performance of operations 408-408 of the method 400. In some examples, the base lid 103 is placed onto the fixture 302 soon after the base lid 103 is formed from a palm leaf. In some examples, the base lid 103 is placed onto the fixture 302 before the base lid 103 is dried.

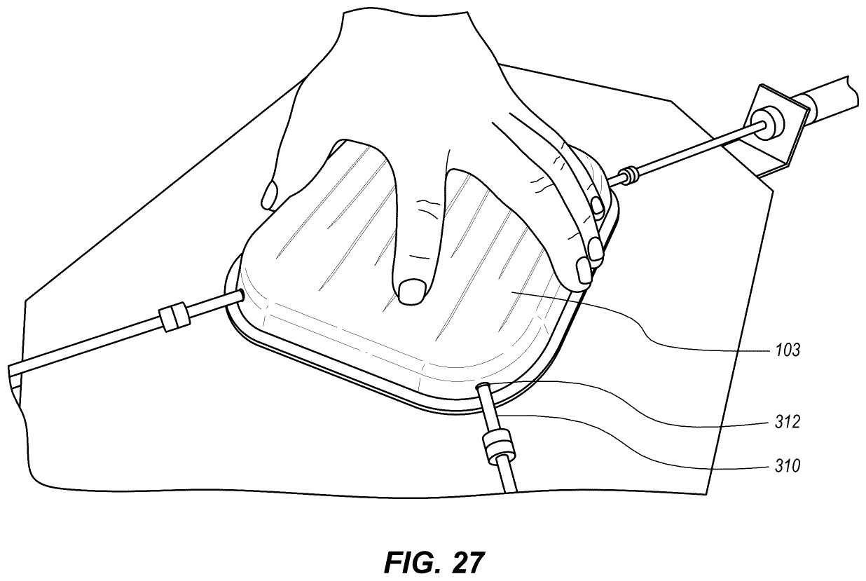

FIG. 27 is a perspective view of a base lid 103 with pistons 310 inserted therein in operation 404 of the method 400 of FIG. 25. In some examples, the pistons 310 are inserted approximately two millimeters into the base lid 103, such as, for example, two millimeters into the base lid 103. In some examples, each of the pistons 310 are inserted such that the free end 312 is inserted into a corner of the base lid 103. In some examples, the free end 312 of each of the pistons 310 is inserted into a corner of a downstanding lip of the base lid 103.

In some examples, each of the free ends 312 of the pistons 310 contact the base lid 103 and are inserted into the base lid 103 at the same time. In some examples, as the free ends 312 of the pistons 310 contact the base lid 103, the material of the base lid 103 is pushed inward by pressure that is applied by the free ends 312 of the pistons 310 to form a protrusion. In some examples, the extent of the protrusion is approximately equal to the amount that the piston 310 is inserted into the base lid 103, such as, for example, two millimeters. In some examples, the free ends 312 of the pistons 310 press portions of the base lid 103 into the piston receiving holes 326 of the fixture 302. In some examples, the portions of the base lid 103 are compressed between the piston receiving holes 326 and the free ends 312 of the pistons 310.

In some examples, in operation 406 of the method 400 of FIG. 25, the pistons 310 are held in place within the base lid 103. In some examples, the pistons 310 are held in place for between approximately two seconds and approximately ten seconds (such as, for example, between two seconds and ten seconds). In some examples, the pistons 310 are held in place for approximately seven seconds. In some examples, the pistons 310 are held in place for approximately eight seconds. In some examples, the pistons 310 continue to provide pressure against the downstanding lip of the base lid 103 throughout the entire period for which they contact the base lid 103.

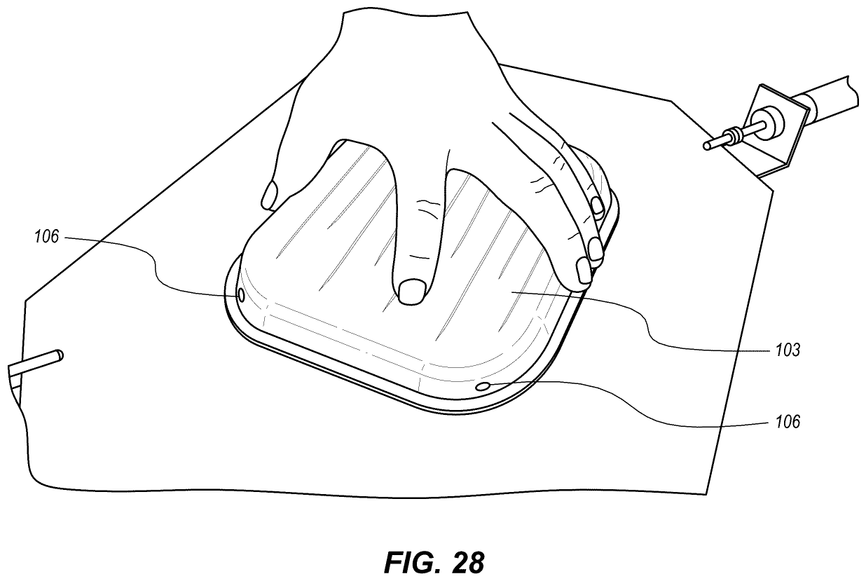

FIG. 28 is a perspective view of a base lid 103 with the pistons 310 removed therefrom in operation 408 of the method 400 of FIG. 25. In some examples, after the pistons 310 are removed from the base lid 103, the base lid 103 takes the shape of the lid 102 and comprises protrusions 106 formed substantially the same as the protrusions 106 of the lid 102. In some examples, after the pistons 310 are removed from the base lid 103, the protrusions 106 formed by the pistons 310 retract from a protrusion amount of approximately two millimeters to a protrusion amount of approximately one millimeter, or approximately one half of a millimeter. In some examples, the protrusions 106 of the base lid 103 retract to a protrusion amount of between approximately one half of a millimeter to approximately one millimeter. In some examples, the protrusions 106 of the base lid 103 retract to a protrusion amount of between approximately one millimeter and approximately two millimeters.

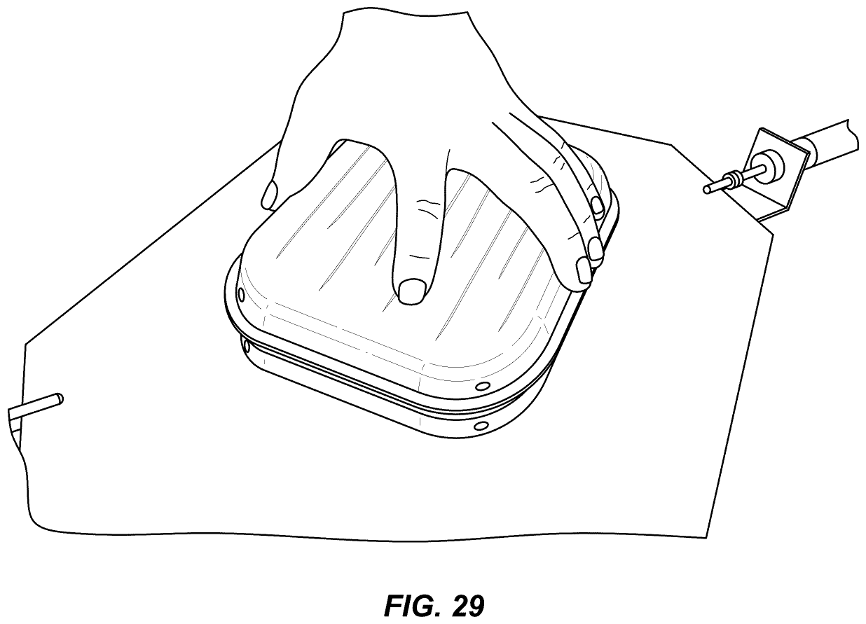

FIG. 29 is a perspective view of a base lid 103 being removed from the fixture 302 in operation 410 of the method 400 of FIG. 25. In some examples, after the base lid 103 is removed from the fixture 302 it undergoes post processing to become the lid 102. In some examples, post processing includes drying the base lid 103.

What is claimed is:

1. A palm leaf container comprising:
a palm leaf dish including an upper flange, a side surface, and a bottom surface, the side surface connecting the upper flange and the bottom surface; and
a palm leaf lid including an upper surface and a downstanding lip, the downstanding lip including a plurality of protrusions arranged thereon;
wherein the palm leaf lid is configured to be coupled to the palm leaf dish such that a portion of the upper flange of the palm leaf dish is received within a cavity formed between one of the plurality of protrusions, the downstanding lip, and the upper surface of the palm leaf lid.

2. The palm leaf container of claim 1, wherein the palm leaf lid comprises at least four protrusions.

3. The palm leaf container of claim 1, wherein each of the plurality of protrusions are arranged at a corner of the downstanding lip.

4. The palm leaf container of claim 1, wherein each of the plurality of protrusions is between approximately one and two millimeters tall.

5. The palm leaf container of claim 1, wherein the palm leaf lid is configured to be uncoupled to the palm leaf dish by removing the portion of the upper flange of the palm leaf dish from the cavity.

6. The palm leaf container of claim 1, wherein the palm leaf lid is configured to be flexed so as to receive the portion of the upper flange of the palm leaf dish within the cavity.

7. The palm leaf container of claim 1, wherein the palm leaf lid is configured to be flexed so as to remove the portion of the upper flange of the palm leaf dish from the cavity.

8. The palm leaf container of claim 1, wherein the upper flange is configured to contact the plurality of protrusions.

9. The palm leaf container of claim 1, wherein each of the plurality of protrusions includes a concave surface formed on an outer side of the downstanding lip and a convex surface formed on an inner side of the downstanding lip.

10. The palm leaf container of claim 1, wherein the upper flange includes one or more undulations arranged thereon.

11. A method of making a palm leaf container, the method comprising:
placing a palm leaf lid of a container on a fixture of a protrusion press;
the palm leaf lid comprising an upper surface and a downstanding lip;
the protrusions press comprising one or more cylinders arranged thereon;
the fixture comprising an outer surface and one or more piston receiving holes configured to receive a piston of one of the one or more cylinders;
inserting a piston of one or more cylinders into the downstanding lip of the palm leaf lid;
holding the piston of the one or more cylinders in the downstanding lip of the palm leaf lid; and
removing the piston of one or more cylinders from the downstanding lip of the palm leaf lid.

12. The method of claim 11, wherein the piston of one or more cylinders includes a free end.

13. The method of claim 12, wherein the free end is a rounded.

14. The method of claim 11, wherein inserting the piston of one or more cylinders into the downstanding lip of the palm leaf lid comprises inserting the piston of one or more cylinders two millimeters into the downstanding lip of the palm leaf lid.

15. The method of claim 11, wherein the one or more cylinders are hydraulic or hydropneumatic cylinders.

16. The method of claim 11, wherein the one or more cylinders comprise four cylinders.

17. The method of claim 16, wherein inserting the piston of one or more cylinders into the downstanding lip of the palm leaf lid comprises simultaneously inserting the piston of the four cylinders into the downstanding lip of the palm leaf lid.

18. The method of claim 11, wherein holding the piston of the one or more cylinders in the downstanding lip of the palm leaf lid comprises holding the piston of the one or more cylinders in the downstanding lip of the palm leaf lid for approximately seven seconds.

19. The method of claim 11, wherein holding the piston of the one or more cylinders in the downstanding lip of the palm leaf lid comprises holding the piston of the one or more cylinders in the downstanding lip of the palm leaf lid for between two seconds and ten seconds.

20. The method of claim 11, further comprising removing the palm leaf lid from the fixture and drying the palm leaf lid.
